(19) United States
(12) Patent Application Publication
(10) Pub. No.: US 2024/0191817 A1
(43) Pub. Date: Jun. 13, 2024

(54) MAGNETIC COUPLING SYSTEM FOR CONDUITS

(71) Applicant: United States of America as represented by the Administrator of NASA, Washington, DC (US)

(72) Inventors: Nicholas Ross, Edwards, CA (US); Eric J. Miller, Lancaster, CA (US); Shideh Naderi, Palmdale, CA (US); Paul Bean, Lancaster, CA (US); Jonathan Lopez-Zepeda, Edwards, CA (US); Francisco Pena, Edwards, CA (US)

(21) Appl. No.: 18/387,929

(22) Filed: Nov. 8, 2023

Related U.S. Application Data
(60) Provisional application No. 63/431,416, filed on Dec. 9, 2022.

(51) Int. Cl. F16L 37/00

(52) U.S. Cl. CPC F16L 37/004

(57) ABSTRACT

A magnetic coupling system that includes a first housing disposed about an end of a first conduit. The first housing includes an axially-extending annular flange. A first annular magnetic element, coupled to the first housing and concentric with the annular flange, has a first plurality of magnetic polarities disbursed thereabout. A second housing, disposed about an end of a second conduit, includes an axially-extending annular channel for engagement with the annular flange. A second annular magnetic element is coupled to the second housing and is concentric with the annular channel. An air gap is disposed between the first annular magnetic element and the second annular magnetic element when the annular flange is engaged in the annular channel. The second annular magnetic element has a second plurality of magnetic polarities disbursed thereabout.

### CROSS-REFERENCE TO RELATED PATENT APPLICATION(S)

This patent application claims the benefit of and priority to U.S. Provisional Application No. 63/431,416, filed on Dec. 9, 2022, the contents of which is hereby incorporated by reference in its entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefor.

### BACKGROUND OF THE INVENTION

This invention relates to magnetic couplings. More specifically, the invention is magnetic coupling for use in coupling ends of two conduits.

Pipe or conduit couplings can vary greatly in terms of complexity, ease of use, strength of the applied coupling force, fluid sealing capability, environmental robustness based on where the coupling will be deployed, etc. For example, space environments such as those found on the Moon or Mars present a number of challenges when designing couplings between ends of fluid-carrying conduits. The environments are very dusty and generally present a broad range of temperature extremes. Further, for personnel working in these environments, the required space suits limit one's dexterity and ability to manipulate many conventional mechanical couplings. There is also a need to limit the amount and types of tools one needs to carry in a space environment.

### BRIEF SUMMARY OF THE INVENTION

Accordingly, it is an object of the present invention to provide a coupling for joining the ends of two pipes or conduits.

Another object of the present invention is to provide a coupling for joining two pipes or conduits in a space environment.

Still another object of the present invention is to provide a pipe or conduit coupling that can be operated without the use of any tools.

Other objects and advantages of the present invention will become more obvious hereinafter in the specification and drawings.

In accordance with the present invention, a magnetic coupling system includes a first housing disposed about or around an end of a first conduit. The first housing includes an axially-extending annular flange. A first annular magnetic element is coupled to the first housing and is concentric with the annular flange. The first annular magnetic element has a first plurality of magnetic polarities disbursed thereabout. A second housing is disposed about or around an end of a second conduit. The second housing includes an axially-extending annular channel for engagement with the annular flange. A second annular magnetic element is coupled to the second housing and is concentric with the annular channel. An air gap is disposed between the first annular magnetic element and the second annular magnetic element when the annular flange is engaged in the annular channel. The second annular magnetic element has a second plurality of magnetic polarities disbursed thereabout.

These and other features, advantages, and objects of the present invention will be further understood and appreciated by those skilled in the art by reference to the following specification, claims, and appended drawings.

### BRIEF DESCRIPTION OF THE DRAWING(S)

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of a magnetic coupling joining the ends of two conduits in accordance with an embodiment of the present invention;

FIG. 2 is an isolated plan view taken along line 2-2 in FIG. 1 of the axial end face of one of the magnetic coupling's annular magnetic elements in accordance with an embodiment of the present invention;

FIG. 3A is an isolated plan view taken along line 3-3 in FIG. 1 of the axial end face of the opposing one of the magnetic coupling's annular magnetic elements in a magnetic attraction position relative to the annular magnetic element shown in FIG. 2 in accordance with an embodiment of the present invention; and

FIG. 3B is an isolated plan view taken along line 3-3 in FIG. 1 of the axial end face of the opposing one of the magnetic coupling's annular magnetic element in a magnetic repulsion position relative to the annular magnetic element shown in FIG. 2 in accordance with an embodiment of the present invention.

### DETAILED DESCRIPTION OF THE

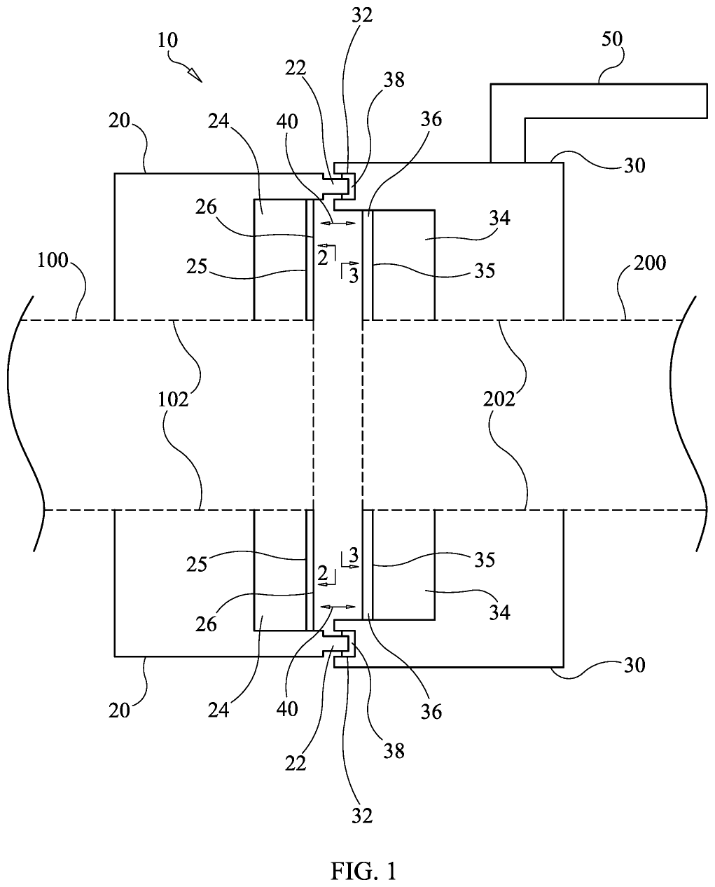

FIG. 1 shows a magnetic coupling joining two conduits 100 and 200 is illustrated and is referenced generally by numeral 10. Conduits 100 and 200 are illustrated in dashed lines to indicate that they provide the operational environment for the present invention but that they are not part of the present invention. Conduits 100 and 200 can be fluid-carrying conduits or can be the outer casings for cable(s). Accordingly, each of conduits 100 and 200 could also include features to support fluid or cable passage between the two conduits where such features are not limitations of the present invention.

In general, magnetic coupling 10 has one magnetic portion coupled to conduit 100 and a second magnetic portion coupled to conduit 200. The two magnetic portions are movable between a magnetic attraction position to couple conduits 100 and 200 and a magnetic repulsion position to facilitate the uncoupling of conduits 100 and 200. As will be explained further below, the positions of the two magnetic portions are readily achieved without the use of any tools. In addition, some embodiments of the present invention's magnetic coupling can be configured to minimize dust intrusion that could damage the magnetic coupling or compromise the material (e.g., fluid, cables, etc.) housed/transported in conduits 100 and 200. For purposes of the present invention, magnetic coupling 10 will be described for such dust intrusion protection.

Magnetic coupling 10 includes a first housing 20 coupled to an end 102 of conduit 100 and a second housing 30 coupled to an end 202 of conduit 200. Housings 20 and 30 are annular structures circumscribing ends 102 and 202, respectively. In general, housings 20 and 30 are rigid structures that support the magnetic and dust-intrusion-protection features of the present invention as will be explained further below.

Housing 20 includes an annular flange 22 that extends axially away from housing 20 and conduit end 102 as illustrated. Housing 30 includes an annular channel 32 that extends axially away from housing 30 and conduit end 202 as illustrated. Housings 20 and 30 are configured such that annular flange 22 is engaged in annular channel 32 when conduits 100 and 200 are joined as shown. For the illustrated embodiment that includes dust-intrusion protection, a seal 38 is disposed in annular channel 32 so that an annular fluid and dust-intrusion seal is formed when annular flange 22 is engaged in annular channel 32. In some embodiments of the present invention, seal 38 can be a material (e.g., TEFLON, nitrile and compounds thereof, polytetrafluoroethylene (PTFE), silicone, etc.) that supports relative sliding motion (i.e., minimizes friction) between annular flange 22 and seal 38 for reasons to be described further below. In some embodiments of the present invention, seal 38 is configured to be partially compressible when annular flange 22 is engaged in annular channel 32.

Coupled to housing 20 is an annular magnetic element 24 concentric with and circumscribed by annular flange 22. In a similar fashion, an annular magnetic element 34 is coupled to housing 30 and is concentric with and circumscribed by annular channel 32. Annular magnetic elements 24 and 34 are passive magnetic structures having respective axial end faces 25 and 35 that oppose one another when annular flange 22 is engaged in annular channel 32. More specifically and in accordance with the present invention, an air gap (indicated by two-headed arrow 40) separates axial end faces 25 and 35 when annular flange 22 is engaged in annular channel 32. Air gap 40 is maintained and protects axial end faces when annular magnetic elements 24 and 34 experience relative movement there between during coupling and uncoupling operations as will be described further below. It is to be understood that the relative size of air gap 40 has been exaggerated for clarity of illustration.

In some embodiments of the present invention, each of axial end faces 25 and 35 can be covered by a non-magnetic material 26 and 36, respectively. Material coverings 26 and 36 protect axial end faces 25 and 35 from damage and provide a cleanable (e.g., via wiping) surface if/when contaminants collect thereon. Suitable materials for material covering 26 and 36 include, but are not limited to, the materials noted above for seal 38 and/or other materials suitable for the environment where magnetic coupling 10 will be deployed.

The present invention uses annular magnetic elements 24 and 34 to provide both coupling and uncoupling forces for magnetic coupling 10. In general, annular magnetic elements 24 and 34 are configured to magnetically attract one another when in one relative position and to magnetically repel one another when in a second relative position. In the illustrated embodiment, the relative position of annular magnetic elements 24 and 34 (and their respective axial end faces 25 and 35) are established via relative rotational movement between the annular magnetic elements. To facilitate the relative rotational movement, a handle can be coupled to one or both of housings 20 and 30. For example, in the illustrated embodiment, if conduit 100 and housing 20 are configured to be fixed in their position, it may be sufficient to provide a handle 50 only on housing 30 as illustrated although another handle or grip (not shown) could be provided on housing 20 to improve leverage when imparting a rotational force to housing 30. The configuration of such handle(s) or grip(s) is not a limitation of the present invention.

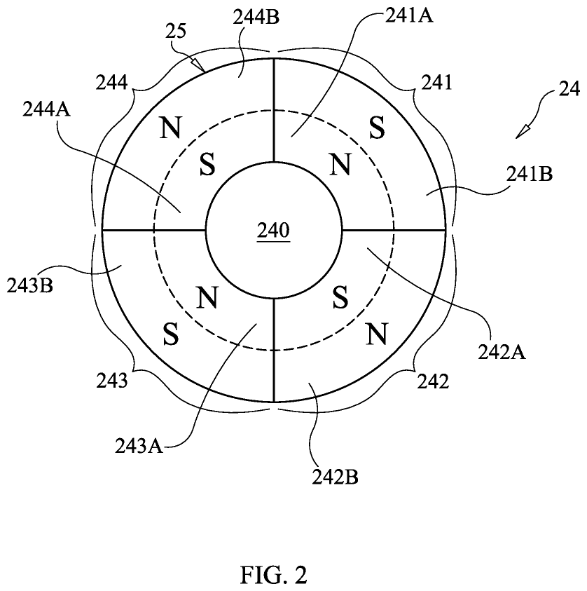

Referring now to FIG. 2, an isolated plan view of axial end face 25 of annular magnetic element 24 is illustrated in accordance with an embodiment of the present invention. In general, annular magnetic element 24 presents a plurality of magnetic polarities disbursed in a circumferential arrangement about an open center region 240 through which conduit end 102 (FIG. 1) abuts, passes through, and/or is coupled to. The arrangement or pattern of polarities can be varied without departing from the scope of the present invention. The circumferential arrangement of magnetic polarities can be fabricated using individual magnets, a singular magnet having disbursed polarities, a singular magnetic element whose polarities are “printed” thereon, etc., without departing from the scope of the present invention. In some embodiments of the present invention, the magnetic polarities are disbursed using arc-shaped regions that can span an arc as large as 180°

By way of an illustrative embodiment, four arc-shaped regions 241-244 are shown in FIG. 2 although fewer or more arc-shaped regions could be used without departing from the scope of the present invention. Each of regions 241-244 spans a 90° arc of annular magnetic element 24. Each of regions 241-244 includes an inner radial portion and an outer radial portion where the two portions have opposing magnetic polarities. For example, an inner radial portion 241A of magnet 241 has a North (“N”) magnetic polarity and an outer radial portion 241B has a South (“S”) magnetic polarity. In accordance with the present invention, adjacent arc-shaped regions are similarly configured with inner and outer radial portions. However, the opposing magnetic polarities in adjacent regions are reversed. Thus, for example and as illustrated in FIG. 2, regions 242 and 244 adjacent to region 241 have respective inner radial portions 242A and 244A with a South magnetic polarity, and have respective outer radial portions 242B and 244B with a North magnetic polarity.

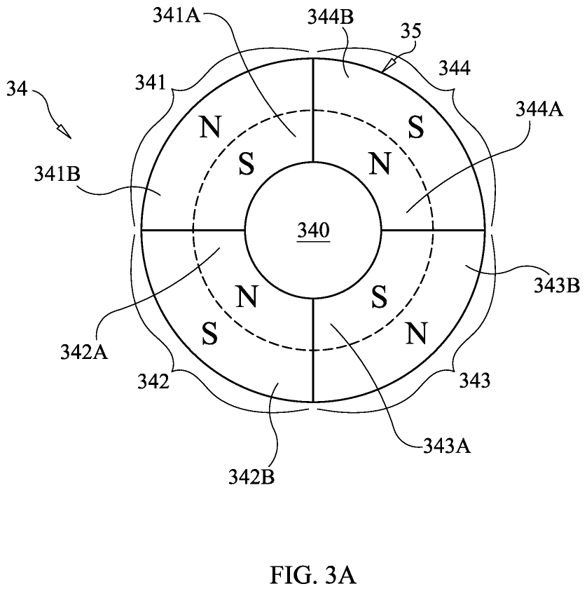

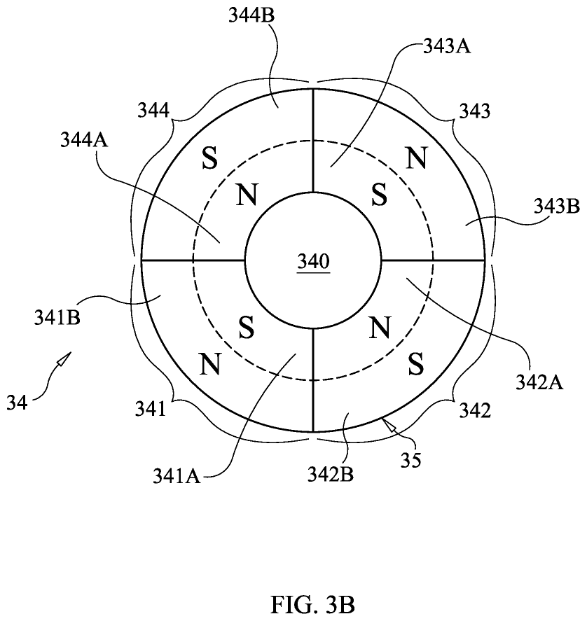

Referring now to FIGS. 3A and 3B, isolated plan views of axial end face 35 of annular magnetic element 34 are illustrated in two positions. Similar to annular magnetic element 24, annular magnetic element 34 is comprised of a plurality of arc-shaped regions in a circumferential arrangement about an open center region 340 through which conduit end 202 (FIG. 1) abuts, passes through, and/or is coupled to. The number and size (i.e., arc length) of arc-shaped regions used for annular magnetic element 34 matches that used for annular magnetic element 24. Thus, for the illustrated embodiment, four arc-shaped regions 341-344 are shown. Each of regions 341-344 spans a 90° arc of annular magnetic element 34. Each of regions 341-344 includes an inner radial portion and an outer radial portion where the two portions have opposing magnetic polarities. Adjacent regions are similarly configured with inner and outer radial portions but with the opposing magnetic polarities in adjacent regions being reversed.

FIG. 3A illustrates the position of annular magnetic element 34 in its magnetic attraction position with respect to annular magnetic element 24, while FIG. 3B illustrates the position of annular magnetic element 34 (rotated 90° relative to its position in FIG. 3A) in its magnetic repulsion position with respect to annular magnetic element 24. When axial end faces 25 and 35 face one another and are positioned as illustrated in FIGS. 2 and 3A, regions 241 and 341 are aligned, regions 242 and 342 are aligned, regions 243 and 343 are aligned, and regions 244 and 344 are aligned. In this position, the polarities of all the regions are aligned for magnetic attraction so that the entirety of the axial end faces are magnetically attracted to one another to facilitate and maintain the coupled position of magnetic coupling 10.

When annular magnetic element 34 is rotated through 90° of in-plane rotation (relative to the position of annular magnetic element 24 in FIG. 2) as illustrated in FIG. 3B, regions 241 and 344 are aligned, regions 242 and 341 are aligned, regions 243 and 342 are aligned, and regions 244 and 343 are aligned. The presence of a friction reducing seal 38 facilitates such rotation. When this occurs, the polarities of all the regions are aligned in magnetic repulsion so that the entirety of end faces 24 and 35 are magnetically repelled from one another to facilitate the uncoupling of magnetic coupling 10. The 90° of in-plane rotation of annular magnetic element 34 can be in the opposite direction to that illustrated in FIG. 3B without departing from the scope of the present invention.

The advantages of the present invention are numerous. The passive magnetic coupling can be used in the joining of pipes/conduits for a variety of applications without the use of tools and without requiring much manual dexterity. The illustrated embodiments described herein are particularly well-suited for use in dusty space environments where space personnel operational personnel will be wearing space suits that limit one's manual dexterity. The magnetic elements provide a tactile feel when performing coupling/uncoupling operations.

Although the invention has been described relative to specific embodiments thereof, there are numerous variations and modifications that will be readily apparent to those skilled in the art in light of the above disclosure. For example, in some embodiments of the present invention, the annular magnetic elements can be disposed outside of the housings' annular flange and annular channel, i.e., the annular magnetic elements will circumscribe their respective annular flange or annular channel. In some embodiments of the present invention, the above-described seal can be omitted for applications where dust intrusion and/or fluid leakage is of no concern. In some embodiments of the present invention, the above-described housings and/or annular magnetic elements can be configured to incorporate rotational stops to limit the rotation of the coupling to its magnetic attraction/repulsion positions. In some embodiments of the present invention, material covering 36 and seal 38 can be the same material and configured as a monolithic element. It is therefore to be understood that, within the scope of the appended claims, the invention may be practiced other than as specifically described.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the disclosure. Thus, the embodiments shown herein are not intended to be limiting but are to be accorded the widest scope consistent with the following claims and the principles and novel features disclosed herein.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” As used herein, the term “and/or” includes any and all combinations of one or more of the associated listed items. As also used herein, the term “combinations thereof” includes combinations having at least one of the associated listed items, wherein the combination can further include additional, like non-listed items. Further, the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

Reference throughout the specification to “another embodiment”, “an embodiment”, “exemplary embodiments”, and so forth, means that a particular element (e.g., feature, structure, and/or characteristic) described in connection with the embodiment is included in at least one embodiment described herein, and can or cannot be present in other embodiments. In addition, it is to be understood that the described elements can be combined in any suitable manner in the various embodiments and are not limited to the specific combination in which they are discussed.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A magnetic coupling system, comprising:
a first housing adapted to be disposed about an end of a first conduit, the first housing having an axially-extending annular flange;
a first annular magnetic element coupled to the first housing and concentric with the annular flange, the first annular magnetic element having a first plurality of magnetic polarities disbursed thereabout;
a second housing adapted to be disposed about an end of a second conduit, the second housing having an axially-extending annular channel for engagement with the annular flange; and
a second annular magnetic element coupled to the second housing and concentric with the annular channel, wherein an air gap is disposed between the first annular magnetic element and the second annular magnetic element when the annular flange is engaged in the annular channel, the second annular magnetic element having a second plurality of magnetic polarities disbursed thereabout.

2. The magnetic coupling system of claim 1, wherein when the annular flange is engaged in the annular channel, the first annular magnetic element and the second annular magnetic element are magnetically attracted to one another when in a first relative position, and the first annular magnetic element and the second annular magnetic element are magnetically repelled from one another in a second relative position.

3. The magnetic coupling system of claim 2, further comprising a handle coupled to at least one of the first housing and the second housing for aiding movement of at least one of the first annular magnetic element and the second annular magnetic element to achieve one of the first relative position and the second relative position.

4. The magnetic coupling system of claim 1, further comprising a seal disposed within the annular channel for engagement with the annular flange when the annular flange is engaged in the annular channel.

5. The magnetic coupling system of claim 1, further comprising:
a first non-magnetic material covering the first annular magnetic element; and
a second non-magnetic material covering the second annular magnetic element wherein the air gap is maintained when the annular flange is engaged in the annular channel.

6. The magnetic coupling system of claim 1, wherein each of the first annular magnetic element and the second annular magnetic element comprises a plurality of arc-shaped regions, each of the arc-shaped regions having an inner radial arc portion and an outer radial arc portion having opposing magnetic polarities, wherein for adjacent ones of the arc-shaped regions, the opposing magnetic polarities are reversed.

7. The magnetic coupling system of claim 6, wherein each of the arc-shaped regions spans an arc not to exceed 180°.

8. A magnetic coupling system, comprising:
a first housing adapted to be disposed about an end of a first conduit, the first housing having an axially-extending annular flange;
a first annular magnetic element coupled to the first housing and circumscribed by the annular flange, the first annular magnetic element having a first plurality of magnetic polarities disbursed thereabout;
a second housing adapted to be disposed about an end of a second conduit, the second housing having an axially-extending annular channel for engagement with the annular flange; and
a second annular magnetic element coupled to the second housing and circumscribed by the annular channel, wherein an air gap is disposed between the first annular magnetic element and the second annular magnetic element when the annular flange is engaged in the annular channel, the second annular magnetic element having a second plurality of magnetic polarities disbursed thereabout.

9. The magnetic coupling system of claim 8, wherein when the annular flange is engaged in the annular channel, the first annular magnetic element and the second annular magnetic element are magnetically attracted to one another when in a first relative rotational position, and the first annular magnetic element and the second annular magnetic element are magnetically repelled from one another in a second relative rotational position.

10. The magnetic coupling system of claim 9, further comprising a handle coupled to at least one of the first housing and the second housing for aiding rotational movement of at least one of the first annular magnetic element and the second annular magnetic element to achieve one of the first relative rotational position and the second relative rotational position.

11. The magnetic coupling system of claim 8, further comprising a seal disposed within the annular channel for engagement with the annular flange when the annular flange is engaged in the annular channel.

12. The magnetic coupling system of claim 8, further comprising:
a first non-magnetic material covering the first annular magnetic element; and
a second non-magnetic material covering the second annular magnetic element wherein the air gap is maintained between the first non-magnetic material and the second non-magnetic material when the annular flange is engaged in the annular channel.

13. The magnetic coupling system of claim 8, wherein each of the first annular magnetic element and the second annular magnetic element comprises a plurality of arc-shaped regions, each of the arc-shaped regions having an inner radial arc portion and an outer radial arc portion having opposing magnetic polarities, wherein for adjacent ones of the arc-shaped regions, the opposing magnetic polarities are reversed.

14. The magnetic coupling system of claim 13, wherein each of the arc-shaped regions spans an arc not to exceed 180°.

15. A magnetic coupling system, comprising:
a first housing adapted to be disposed about an end of a first conduit, the first housing having an axially-extending annular flange;
a first annular magnetic element coupled to the first housing and circumscribed by the annular flange, the first annular magnetic element having a first axial end face, the first annular magnetic element having a first plurality of magnetic polarities disbursed thereabout;
a second housing adapted to be disposed about an end of a second conduit, the second housing having an axially-extending annular channel for engagement with the annular flange;
a second annular magnetic element coupled to the second housing and circumscribed by the annular channel, the second annular magnetic element having a second axial end face wherein an air gap is disposed between the first axial end face and the second axial end face when the annular flange is engaged in the annular channel, the second annular magnetic element having a second plurality of magnetic polarities disbursed thereabout; and
a seal disposed within the annular channel for engagement with the annular flange when the annular flange is engaged in the annular channel.

16. The magnetic coupling system of claim 15, wherein when the annular flange is engaged in the annular channel, the first annular magnetic element and the second annular magnetic element are magnetically attracted to one another when in a first relative rotational position, and the first annular magnetic element and the second annular magnetic element are magnetically repelled from one another in a second relative rotational position.

17. The magnetic coupling system of claim 16, further comprising a handle coupled to at least one of the first housing and the second housing for aiding rotational movement of at least one of the first annular magnetic element and the second annular magnetic element to achieve one of the first relative rotational position and the second relative rotational position.

18. The magnetic coupling system of claim 15, further comprising:
a first non-magnetic material covering at least the first axial end face of the first annular magnetic element; and
a second non-magnetic material covering at least the second axial end face of the second annular magnetic element wherein the air gap is maintained between the first non-magnetic material and the second non-magnetic material when the annular flange is engaged in the annular channel.

19. The magnetic coupling system of claim 15, wherein each of the first annular magnetic element and the second annular magnetic element comprises a plurality of arc-shaped regions, each of the arc-shaped regions having an inner radial arc portion and an outer radial arc portion having opposing magnetic polarities wherein, for adjacent ones of the arc-shaped regions, the opposing magnetic polarities are reversed.

20. The magnetic coupling system of claim 19, wherein each of the arc-shaped regions spans an arc not to exceed 180°.
